(19) United States
(12) Patent Application Publication
(10) Pub. No.: US 2011/0186779 A1
(43) Pub. Date: Aug. 4, 2011

(54) PHOTOVOLTAIC MODULE RECYCLING

(76) Inventors: John Bohland, Oregon, OH (US); Andreas Wade, Brelin (DE)

(21) Appl. No.: 13/058,959

(22) PCT Filed: Aug. 13, 2009
(86) PCT No.: PCT/US09/53705

§ 371 Date: Apr. 15, 2011

Related U.S. Application Data
(60) Provisional application No. 61/088,485, filed on Aug. 13, 2008.

(51) Int. Cl. C09K 11/88; B22F 1/00; C01B 19/04; C01B 19/02; C01G 11/02; C01B 33/02; C09K 11/66

(52) U.S. Cl. 252/301.6 S; 75/343; 423/509; 423/510; 423/566.1; 423/348; 423/99; 423/109; 252/301.4 F

(57) ABSTRACT

A method for reclaiming a semiconductor material from a glass substrate is disclosed, the method comprises the steps of providing at least one glass substrate having the semiconductor material disposed thereon, reducing the glass substrate having a semiconductor material disposed thereon to a plurality of glass particles having the semiconductor material disposed thereon by introducing a source of energy thereto, separating the semiconductor material from the plurality of glass particles to obtain semiconductor particles, and pyrometallυrgicaHy refining the semiconductor particles and the fine glass particles.

### CROSS-REFERENCE TO RELATED APPLICATION

This application claims the benefit of U.S. Provisional Patent Application Ser. No. 61/088,485 filed on Aug. 13, 2008.

### FIELD OF THE INVENTION

The present invention relates generally to a method for reclaiming materials used in the manufacture of photovoltaic modules.

### BACKGROUND OF THE INVENTION

The use of cadmium telluride in photovoltaic modules has increased due to the need to generate renewable, non-polluting, and low cost electricity as an alternative to fossil fuels. However, because the cadmium, cadmium compounds, and tellurium used in the manufacture of thin-film cadmium telluride photovoltaic modules have hazardous toxicological properties, end-of-life disposal of the photovoltaic modules has become a concern.

Methods for recovering cadmium, cadmium compounds, and tellurium from end-of-life photovoltaic modules have been developed to reclaim the metallic materials to militate against polluting the environment caused by disposal of the photovoltaic modules. One such method is disclosed in U.S. Pat. No. 6,129,779 to Bohland et al. for RECLAIMING METALLIC MATERIAL FROM AN ARTICLE COMPRISING A NON-METALLIC FRIABLE SUBSTRATE hereby incorporated herein by reference in its entirety. The '779 patent discloses a method of reclaiming a metallic semiconductor material from a non-metallic substrate by crushing the material-coated substrate into a plurality of pieces, and disposing the plurality of pieces in an acidic solution to dissolve the metallic semiconductor material. The plurality of pieces is then removed from the solution and a precipitation agent is added to the acidic solution to precipitate out the metallic materials, thereby recovering the metallic material.

It would be desirable to develop a method for reclaiming materials used in the manufacture of photovoltaic modules that does not require a mechanical crushing of the glass substrate to maximize process efficiency and minimize operation costs.

### SUMMARY OF THE INVENTION

Concordant and congruous with the present invention, a method for reclaiming materials used in the manufacture of thin-film photovoltaic modules that does not require a mechanical crushing the glass substrate to maximize process efficiency and minimize operation costs has surprisingly been discovered.

In one embodiment of the invention, a method for reclaiming a semiconductor material from a photovoltaic module, comprises the steps of providing at least one photovoltaic module including a glass substrate having a semiconductor material disposed thereon; reducing the photovoltaic module to a plurality of glass particles having the semiconductor material disposed thereon by introducing a source of energy thereto; separating the semiconductor material from the plurality of glass particles to obtain semiconductor particles; and pyrometallurgically refining the semiconductor particles and the fine glass particles.

In another embodiment of the invention, a method for reclaiming a semiconductor material from a photovoltaic module, comprises the steps of providing at least one multi-layer photovoltaic module including a glass substrate having a semiconductor material disposed thereon; delaminating the photovoltaic module with pyrolysis using a heated inert gas to separate glass layers having a semiconductor coating from non-glass layers; reducing the glass layers to a plurality of glass particles having the semiconductor material disposed thereon by introducing a source of energy thereto; separating the semiconductor material from the plurality of glass particles to obtain semiconductor particles; and pyrometallurgically refining the semiconductor particles and the fine glass particles.

In another embodiment, a method for reclaiming a semiconductor material from a photovoltaic module, comprises the steps of providing at least one photovoltaic module including a glass substrate having a semiconductor material disposed thereon; reducing the photovoltaic module to a plurality of semiconductor coated glass particles by introducing a source of energy thereto, wherein the source of energy is one of thermal energy, acoustic energy, and a combination of the foregoing; separating the semiconductor material from the plurality of glass particles to obtain semiconductor particles; and pyrometallurgically refining the semiconductor particles and the fine glass particles.

### BRIEF DESCRIPTION OF THE DRAWING

The above as well as other objects and advantages of the invention will become readily apparent to those skilled in the art from reading the following detailed description of a preferred embodiment of the invention in the light of the accompanying drawing, in which:

FIG. 1 is a flow diagram illustrating a method of reclaiming materials used in the manufacture of thin-film photovoltaic modules according to an embodiment of the invention; and

FIG. 2 is a flow diagram illustrating a method of reclaiming materials used in the manufacture of multi-layer thin-film photovoltaic modules according to another embodiment of the invention.

### DETAILED DESCRIPTION OF THE PREFERRED EMBODIMENT

The following detailed description and appended drawing describes and illustrates various exemplary embodiments of the invention. The description and drawing serves to enable one skilled in the art to make and use the invention, and are not intended to limit the scope of the invention in any manner. In respect of the methods disclosed, the steps presented are exemplary in nature, and thus, the order of the steps is not necessary or critical.

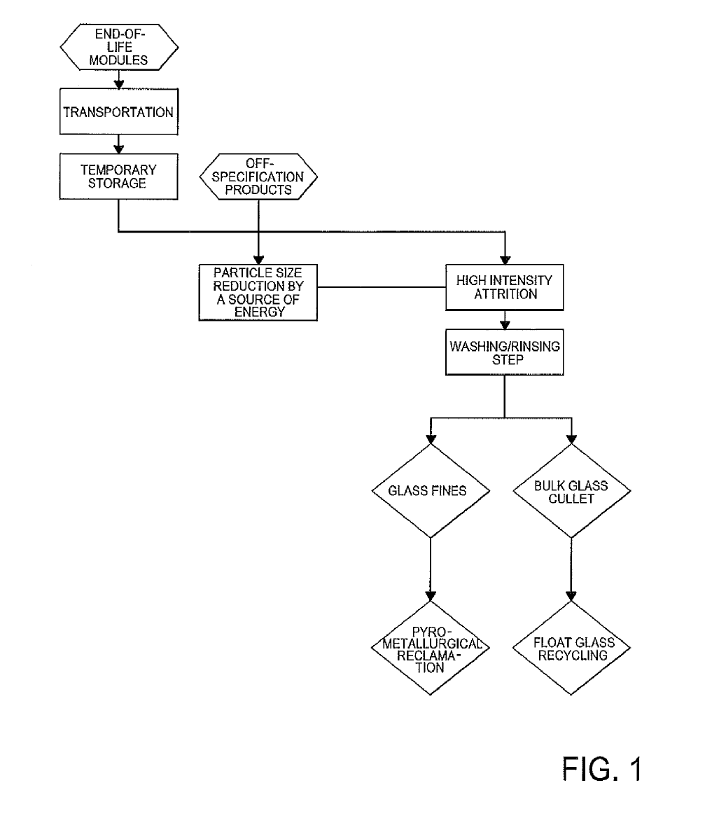

With reference to the flow diagram of FIG. 1, a flow diagram for a method for reclaiming a semiconductor material from a photovoltaic module is illustrated. It is understood that the module may be a thin-film semiconductor module and may have any number of layers and any conventional material may be used to form the layers, as desired. For example, the module may include an outer layer comprising glass overlaid by and adhered to an ethylene-vinyl acetate (EVA) layer. The glass may be a soda-lime glass, typically having a low-E coating that is optically transparent and electrically conductive. An example of such glass is produced by Pilkington Glass Co. and is designated as TEC-15. A metal contact layer may be adhered to and overlay the EVA layer. A first semiconductor layer comprising cadmium telluride (CdTe) may adhere to and overlay the metal contact layer. A second semiconductor later comprising cadmium sulfide (CdS) may be adhered to and overlay the CdTe layer. A metallic layer of tin oxide doped with fluorine (SnO₂:F) may be adhered to and overlay the CdS layer, and a second outer layer comprising glass may be adhered to and overlay the SnO₂:F (TEC-15) layer.

It is understood that the outer layers of the module may also be formed from other materials such as a metal, a wood, and a plastic, for example. The semiconductor layers may comprise barium, cadmium, lead, mercury, selenium, silver, tellurium, gold, cadmium sulfide, cadmium telluride and combinations thereof, for example, as desired. Aside from the module described above, the module may also be a copper-indium-gallium-diselenide module, a cadmium sulfide/copper-indium-selenium alloy module, an amorphous silicon or thin-film polycrystalline silicon module, and a zinc oxide sulfide hydroxide/copper-indium-gallium-diselenide module. Further, the method described herein may also be used for a cathode ray tube, lead acid battery casing, a substrate having lead paint thereon, a fluorescent lamp, glass mirrors, a semiconductor conductor material on a glass substrate, and plasma flat panel displays to recover a metallic material from a non-metallic, such as glass, substrate. As a non-limiting example, the process described herein utilizes a photovoltaic module having a semiconductor material disposed on a glass layer. It is understood that the module could include any material formed on any layer and any number of layers, as described herein.

End-of-life photovoltaic modules and/or manufactured modules that are off-specification are provided for recycling using the process described herein. The modules are then broken into a plurality of glass particles having the semiconductor material disposed thereon. The plurality of glass particles includes glass collets and glass particles smaller than the glass collets, referred to herein as fine glass particles. As used herein, glass cullet is pieces of glass between about 2 mesh and about 70 mesh, while fine glass particles are particles of glass smaller than about 70 mesh. The particle size reduction of the module may be performed by providing a source of energy on or against the pyrolized module, such as thermal energy and acoustic energy, for example. The source of energy may include a flow of steam directed against the module, a flow of liquid nitrogen directed onto the module, a flow of water at a desired temperature directed against the module, a high intensity acoustic energy directed at the module and adapted to break the module, and a combination of the aforementioned sources of energy. It is understood that the module may be subjected to any source of energy to effect particle size reduction that does not require direct mechanical grinding, milling, or shredding. The particle size reduction step may occur in a furnace or in another suitable vessel, as desired.

After the particle size reduction step, the semiconductor material coated on the plurality of glass particles is separated therefrom by an abrasive media, a chemical surfactant, or a combination thereof. The step of using an abrasive, also known as a high intensity attrition step, is adapted to separate the semiconductor material from the glass cutlet without etching the resulting semiconductor material particles. The separation step may occur in the same vessel that the particle size reduction was performed or the separation step may occur in another suitable vessel, as desired.

The fine glass particles and the semiconductor material particles that may be stuck to the glass cullet are removed therefrom by rinsing the glass cullet, fine glass particles, and the semiconductor material particles with one of water, a surfactant, a combination thereof, and any other suitable washing material. A screen is utilized to separate the glass cullet, the semiconductor material particles, and the fine glass particles from any residual liquid used during the separation step and the washing step. The glass cullet may be separated from the semiconductor material particles and fine glass particles by another, appropriately sized screen. The screens may be vibratory screens, as desired. It is understood that any conventional solid particle separation device may be used.

The fine glass particles and the semiconductor material particles are then transferred to another vessel for pyrometallurgical refining. The glass cullet are transferred to another vessel and recycled with a float glass recycling process or the like. During the process described herein, substantially all of the semiconductor material and the semiconductor particles are in a solid phase or a gas phase, and substantially none of the semiconductor material is in a liquid phase.

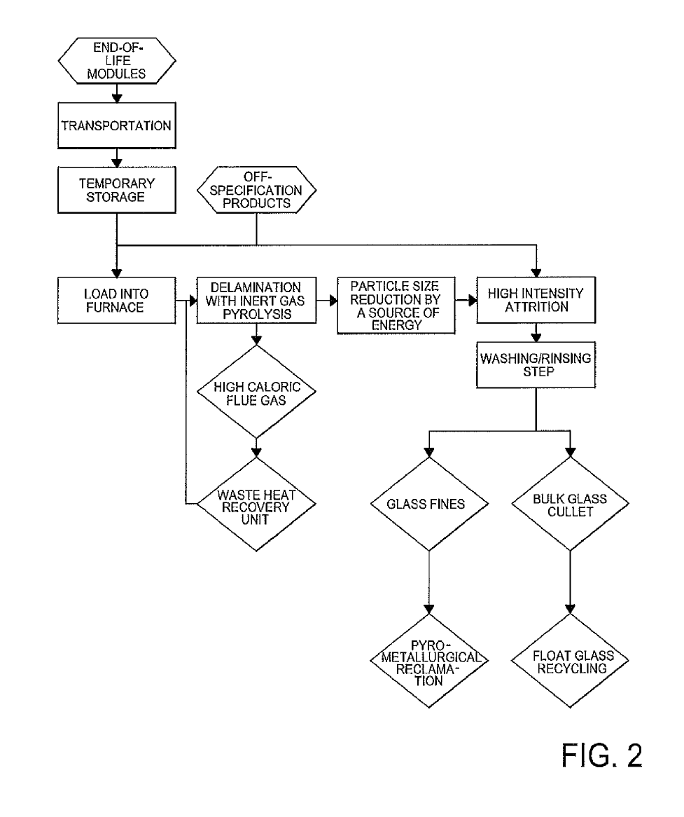

In another embodiment of the invention, and as illustrated by the flow diagram of FIG. 2, if the photovoltaic module has multiple layers, such as a non-glass layer and/or a contact layer, for example, additional steps are required to recycle a semiconductor material from the module. Before the module is reduced to a plurality of particles, the module is transferred to a furnace for delamination thereof with pyrolysis using a heated inert gas such as oxygen, nitrogen, and argon, for example. The heat energy generated in the furnace may be recovered in a waste heat recovery unit and reused. The recycled heat energy may be reused in subsequent delamination steps, for example. The non-glass layers may be separated from the pyrolized glass having the semiconductor material disposed thereon, as desired. The remaining steps of the recycling process are similar to those described above with respect to the process illustrated in FIG. 1.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A method for reclaiming a material coated on a glass substrate, comprising the steps of:
providing at least one glass substrate having a material disposed thereon;
reducing the glass substrate to a plurality of glass particles having the material disposed thereon by introducing a source of energy thereto;
separating the material from the plurality of glass particles to obtain material particles; and
pyrometallurgically refining the material particles.

2. The method of claim 1, wherein the material is one of a semiconductor material and a metallic material.

3. The method of claim 1, wherein the plurality of glass particles comprises glass cullet and fine glass particles.

4. The method of claim 3, further comprising a step of pyrometallurgically refining the fine glass particles.

5. The method of claim 3, further comprising a step of washing one of the semiconductor particles and the metallic material particles, the fine glass particles, and the glass cullet with one of water, a surfactant, a combination thereof, and a washing material to separate one of the semiconductor particles and the metallic particles and the fine glass particles from the glass cullet.

6. The method of claim 5, further comprising a step of separating one of the semiconductor particles and the metallic material particles and fine glass particles from the glass cullet with a screen.

7. The method of claim 1, wherein the source of energy is one of thermal energy, acoustic energy, and a combination of the foregoing.

8. The method of claim 7, wherein the thermal energy is provided by water at a desired temperature, liquid nitrogen, steam, and a combination of the foregoing.

9. The method of claim 1, wherein one of an abrasive media, a surfactant, and a combination of the foregoing is used during the separating.

10. The method of claim 9, wherein the semiconductor particles are not etched during the separating step.

11. The method of claim 1, further comprising a step of recycling the plurality of glass particles with a float glass recycling process.

12. The method of claim 1, wherein substantially all of one of the semiconductor material and the metallic material is in one of a solid phase, a gas phase, and a combination of the foregoing.

13. The method of claim 1, wherein the glass substrate is a photovoltaic module having a semiconductor material disposed thereon.

14. The method of claim 13, wherein the photovoltaic module is a multi-layer photovoltaic module.

15. The method of claim 14, further comprising a step of delaminating the photovoltaic module with pyrolysis using a heated inert gas to separate pyrolized glass layers having a semiconductor material disposed thereon from non-glass layers.

16. The method of claim 15, further comprising a step of recovering thermal energy from the delaminating step.

17. A method for reclaiming a semiconductor material from a glass substrate, comprising the steps of:
providing at least one multi-layer substrate having a glass substrate layer having a semiconductor material disposed thereon;
delaminating the multi-layer substrate with pyrolysis using a heated inert gas to separate glass layers having a semiconductor material disposed thereon from non-glass layers;
reducing the glass layers to a plurality of glass particles having the semiconductor material disposed thereon by introducing a source of energy thereto;
separating the semiconductor material from the plurality of glass particles to obtain semiconductor particles; and
pyrometallurgically refining the semiconductor particles and the fine glass particles.

18. The method of claim 17, wherein the plurality of glass particles comprises glass cullet and fine glass particles.

19. The method of claim 18, further comprising a step of washing the semiconductor particles, the fine glass particles, and the glass cullet with one of water, a surfactant, a combination thereof, and a washing material to separate the semiconductor particles and the fine glass particles from the glass cullet.

20. A method for reclaiming a semiconductor material from a photovoltaic module, comprising the steps of:
providing at least one photovoltaic module including a glass substrate having a semiconductor material disposed thereon;
reducing the photovoltaic module to a plurality of glass particles having the semiconductor material disposed thereon by introducing a source of energy thereto, wherein the source of energy is one of thermal energy, acoustic energy, and a combination of the foregoing;
separating the semiconductor material from the plurality of glass particles to obtain semiconductor particles; and
pyrometallurgically refining the semiconductor particles and the fine glass particles.
